(19) United States
(12) Patent Application Publication
(10) Pub. No.: US 2025/0293717 A1
(43) Pub. Date: Sep. 18, 2025

(54) VOLTAGE STANDING WAVE RATIO (VSWR) MONITORING FOR A RECEIVER

(71) Applicant: QUALCOMM Incorporated, San Diego, CA (US)

(72) Inventors: Saranyan Nagarajan, Hyderabad (IN); Francesco Gatta, San Diego, CA (US); Raveesh Juneja, Hyderabad (IN); Kapil Bhattad, Bangalore (IN); Prasidh Ramabadran, Bangalore (IN)

(21) Appl. No.: 18/602,286

(22) Filed: Mar. 12, 2024

(51) Int. Cl. H04B 1/10; H04B 1/18

(52) U.S. Cl. CPC H04B 1/1027; H04B 1/18; H04B 2001/1072

(57) ABSTRACT

An apparatus includes a receive path, a tuner circuit, and a coupler circuit. The coupler circuit is configured to provide a reference signal to the receive path in a first mode of operation associated with measurement of an incident power associated with the receive path. The coupler circuit is further configured to provide the reference signal to the tuner circuit in a second mode of operation associated with measurement of a reflected power from the tuner circuit to the receive path. The tuner circuit is configured to receive a control signal in accordance with the incident power and the reflected power. The control signal indicates an impedance adjustment associated with the tuner circuit.

### TECHNICAL FIELD

Aspects of the present disclosure relate generally to wireless communication systems, and more particularly, to voltage standing wave ratio (VSWR) monitoring for a receiver within a wireless communication system.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

### BRIEF SUMMARY OF SOME EXAMPLES

In some aspects of the disclosure, an apparatus includes a receive path, a tuner circuit, and a coupler circuit. The coupler circuit is configured to provide a reference signal to the receive path in a first mode of operation associated with measurement of an incident power associated with the receive path. The coupler circuit is further configured to provide the reference signal to the tuner circuit in a second mode of operation associated with measurement of a reflected power from the tuner circuit to the receive path. The tuner circuit is configured to receive a control signal in accordance with the incident power and the reflected power. The control signal indicates an impedance adjustment associated with the tuner circuit.

In some other aspects, a method includes receiving an indication of an incident power associated with a receive path and further includes receiving an indication of a reflected power associated with a tuner circuit. Measurement of the incident power is associated with a first mode of a coupler circuit that is coupled to the receive path, and measurement of the reflected power is associated with a second mode of the coupler circuit. The coupler circuit is coupled to the tuner circuit. The method further includes providing a control signal to the tuner circuit to adjust an impedance associated with the tuner circuit. The control signal is based on the incident power and the reflected power.

In some additional aspects, an apparatus includes a processing system including one or more processors and one or more memories coupled to the one or more processors. The processing system is configured to receive an indication of an incident power associated with a receive path and to receive an indication of a reflected power associated with a tuner circuit. Measurement of the incident power is associated with a first mode of a coupler circuit that is coupled to the receive path, and measurement of the reflected power is associated with a second mode of the coupler circuit. The coupler circuit coupled to the tuner circuit. The processing system is further configured to provide a control signal to the tuner circuit to adjust an impedance associated with the tuner circuit. The control signal is based on the incident power and the reflected power.

In some additional aspects, an apparatus includes a receive circuit, an antenna tuner circuit, and a coupler circuit. The coupler circuit is coupled between the receive circuit and the antenna tuner circuit and has a first port and a second port. The apparatus further includes a feedback receiver circuit, a reference signal generator, and first switching circuit, and a second switching circuit. The first switching circuit is coupled between the coupler circuit and each of the feedback receiver circuit and the reference signal generator. The first switching circuit is configured to selectively couple to either the first port or the second port of the coupler circuit. The second switching circuit is coupled between the first switching circuit and each of the feedback receiver circuit and the reference signal generator. The second switching circuit is configured to selectively couple to either the feedback receiver circuit or the reference signal generator.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a block diagram illustrating a receiver circuit according to one or more aspects.

FIG. 4A is a block diagram illustrating an example of a system according to one or more aspects.

FIG. 4B illustrates an example of a first configuration of a switch during operation of a coupler circuit based on a first mode according to one or more aspects.

FIG. 4C illustrates an example of a second configuration of a switch during operation of a coupler circuit based on a second mode according to one or more aspects.

FIG. 5A is a block diagram illustrating an example configuration of a time slot according to one or more aspects.

FIG. 5B is a block diagram illustrating another example configuration of a time slot according to one or more aspects.

FIG. 6 is a flow chart illustrating an example of a method according to one or more aspects.

FIG. 7 is a flow chart illustrating another example of a method according to one or more aspects.

FIG. 8 is a block diagram of an example of a user equipment (UE) according to one or more aspects.

### DETAILED DESCRIPTION

As more electronic devices transmit and receive wireless signals, noise and interference increases, which may reduce performance of a user equipment (UE) in a wireless communication system. In addition, as UE form factors and component sizes decrease, a UE may be more susceptible to noise and interference in some cases. For example, some UE designs may experience a change in capacitance associated with an antenna when the hand of a user is positioned near to or around the antenna. The change in capacitance may reduce performance, such as by causing or increasing an impedance mismatch between the antenna and a receive path that is coupled to the antenna. Further, as antenna sizes scale down, antennas may be more susceptible to user hand position and other such effects.

A UE in accordance with some aspects of the disclosure may dynamically monitor a voltage standing wave ratio (VSWR) associated with an antenna and a receive path. For example, the UE may include a coupler circuit that “steers” a reference signal toward the receive path in a first mode of operation and toward the antenna and a tuner circuit associated with the antenna in a second mode of operation. The reference signal may correspond to an oscillation signal having a frequency that matches a receive frequency of a downlink signal that is to be received via the receive path.

The UE may measure an incident power during the first mode of operation and may measure a reflected power during a second mode of operation. The UE may estimate the VSWR based on the incident power and the reflected power. The UE may adjust an impedance of the tuner circuit based on the VSWR. In some examples, the UE may iteratively adjust the VSWR to reach a threshold value (or until reaching a threshold amount of time for VSWR adjustment).

In some implementations, the UE initiates VSWR monitoring based on detecting one or more trigger events. For example, the UE may perform VSWR monitoring during an idle mode of operation associated with the receive path. In some examples, the idle mode may be scheduled or unscheduled. For example, the idle mode may correspond to a time period during which no downlink signal is scheduled to be received by the UE. In some other examples, the UE may “drop” one or more symbols of a downlink signal to facilitate VSWR monitoring. In some examples, the UE may request retransmission of one or more dropped symbols, such as via a negative acknowledgement (NACK).

By monitoring VSWR during operation of the UE, the UE may adaptively adjust the impedance of the tuner circuit, changing the impedance that is “seen” by the input of the receive path. As a result, the UE may compensate for changes to capacitance associated with the antenna that may vary during operation of the UE, such as changes to capacitance due to the hand of a user blocking the antenna. As a result, receiver sensitivity of the receive path may be increased, which may improve performance of the UE and which may decrease power consumption of the UE in some circumstances.

In various implementations, the techniques and features described herein may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long-term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km∧2), ultra-low complexity (e.g., ˜10 s of bits/sec), ultra-low energy (e.g., ˜10+years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km∧2), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHZ-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHz, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

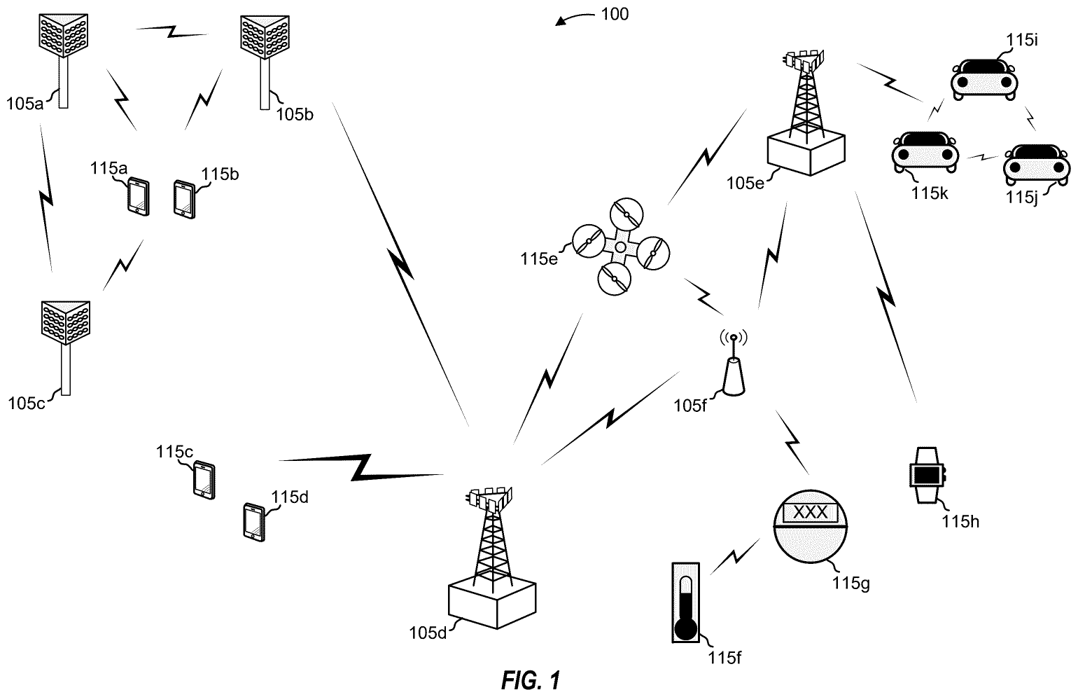

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a smart energy or security device, a solar panel or solar array, municipal lighting infrastructure, water infrastructure, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100. A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports communications with ultra-reliable and redundant links for various types of devices, such as UE 115e. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

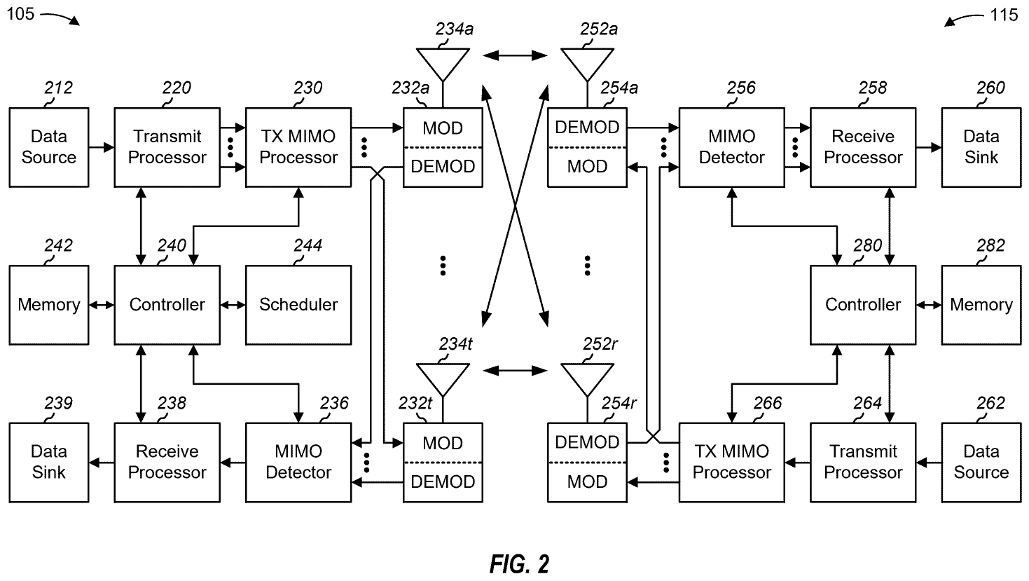

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

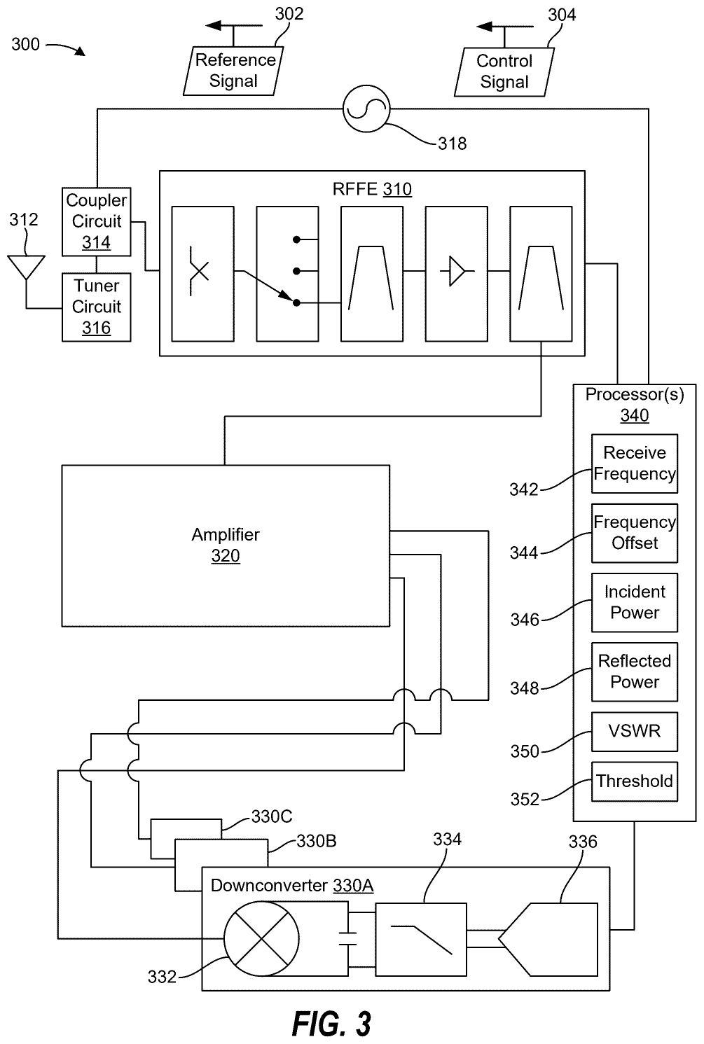

FIG. 3 is a block diagram illustrating a receiver circuit 300 according to one or more aspects. In some embodiments, the receiver circuit 300 may be part of a converged sub-6 Ghz and mm Wave radio frequency (RF) transceiver, a sub-6 GHz radio frequency (RF) transceiver, or a mmWave radio frequency (RF) transceiver. In some embodiments, portions or all of the RF transceiver of FIG. 3 may be located in a single integrated circuit (IC) sharing a common substrate. The receiver circuit 300 may include an antenna 312 to receive radio frequency (RF) signals, such as a phase antenna array. The antenna 312 is coupled to a RF front-end (RFFE) 310, which may include duplexers, SAW filters, switches, LNAs, and/or other transmit or receive circuits for conditioning signals received from the antenna 312. In some embodiments, the RFFE 310 may include separate circuits for conditioning or otherwise processing sub-6 GHz signals, mmWave signals, satellite signals, and/or other signals. For example, the RFFE 310 may include a first plurality of circuits for conditioning a sub-6 GHz signal for further processing by other circuitry and a second plurality of circuits for conditioning a mmWave RF signal for further processing by other circuitry. The output of the RFFE 310 in this example may be a input RF signal to other circuitry comprising the conditioned sub-6 GHz signal and a conditioned mmWave IF signal. The RFFE 310 is coupled to an amplifier 320, such as a low noise amplifier (LNA). The amplifier 320 is coupled to one or more downconverters 330A, 330B, and 330C. Each of the downconverters 330A, 330B, and 330C may include a mixer 332, a baseband filter (BBF) 334, and/or an analog-to-digital converter (ADC) 336. The downconverters 330A, 330B, 330C may include one or more harmonic rejection mixers (HRMs). In some embodiments, the amplifier 320 is shared on an IC with one or more of the RFFE 310 and/or the downconverters 330A, 330B, and 330C.

Interference between wireless signals received at antenna 312 and processed through RFFE 310, amplifier 320, and downconverters 330A-C complicates operation of the receiver circuit 300, particularly when processing a large range of potential frequencies. For example, co-location of processing paths for sub-6 Ghz and mmWave signals in an integrated circuit can create interference between the sub-6 GHz signal harmonics and the mm Wave signals. Interference between sub-6 GHz signals and mm Wave signals may occur because mmWave IF signals corresponding to mmWave RF signals received at an antenna from over-the-air may be located near to sub-6 GHz signals in frequency (e.g., within 1-6 GHZ) and/or located at harmonics of the sub-6 GHz (e.g., at integer multiples of the sub-6 GHz signals).

Interference between wireless signals may be further complicated by carrier aggregation (CA) operation. Carrier aggregation (CA) involves the combination of one or more carrier RF signals to carry a single data stream. Carrier aggregation (CA) improves the flexibility of the wireless devices and improves network utilization by allowing devices to be assigned different numbers of carriers for different periods of time based, at least in part, on historical, instantaneous, and/or predicted bandwidth use by the wireless device. Thus, when a mobile device needs additional bandwidth, additional carriers may be assigned to that wireless device, and then de-assigned and re-assigned to other mobile devices when bandwidth demands change. As carriers are assigned and de-assigned from a mobile device, the interaction of wireless signals may change. For example, different carriers in CA may be in different bands, and certain bands may have harmonics that overlap and/or otherwise interfere with certain other bands.

One or more processors 340 may detect conditions in the RF signal received from the antenna 312 or receive information regarding the carrier configuration from higher levels, such as a MAC layer or network layer. The one or more processors 340 may configure components of the receiver circuit 300 to activate, deactivate, or control portions of the receiver circuit 300 to process an input RF signal. In some embodiments, the one or more processors 340 may configure components to reduce interference between bands within the receiver circuit 300.

In some examples, the one or more processors 340 may include a radio frequency (RF) controller associated with operation of at least some components of the receiver circuit 300. Alternatively, or in addition, the one or more processors 340 may include a baseband processor that receives and processes digital data, such as digital data output from the ADC 336, from the RF controller, one or more other devices, or a combination thereof. Alternatively, or in addition, the one or more processors 340 may include a modem processor. In some examples, the one or more processors 340 may include one or more components described with reference to FIG. 2, such as one or more of the receive processor 258, the transmit processor 264, the TX MIMO processor 266, or the controller 280. In some implementations, at least some features described herein may be implemented on an integrated circuit. For example, in some implementations, any of the receive processor 258, the transmit processor 264, the TX MIMO processor 266, or the controller 280 may be included in the same integrated circuit.

In some aspects of the disclosure, the receiver circuit 300 may include a coupler circuit 314, a tuner circuit 316, and a reference signal generator 318. The one or more processors 340 may be coupled to the reference signal generator 318, and the reference signal generator 318 may be coupled to the coupler circuit 314. The coupler circuit 314 may be coupled to the one or more processors 340 and to the tuner circuit 316. The tuner circuit 316 may be coupled to the antenna 312. In some examples, the coupler circuit 314 may be included in, or may be coupled to, the RFFE 310.

During operation, the reference signal generator 318 may generate a reference signal 302. For example, the one or more processors 340 may provide one or more control signals, such as a control signal 304, to the coupler circuit 314 and to the reference signal generator 318 to generate the reference signal 302. In some examples, the reference signal 302 may have a frequency that is configurable by the one or more processors 340 via the control signal 304. In some examples, the frequency of the reference signal 302 may be based on a sum of a receive frequency 342 and a frequency offset 344. The receive frequency 342 may correspond to a frequency of a receive signal that is to be received by the receiver circuit 300. In some examples, the frequency offset 344 may correspond to a quantity of kilohertz (kHz), such as 100 kHz or another value.

In some aspects of the disclosure, the coupler circuit 314 may receive the reference signal 302 and may selectively provide (or “steer”) the reference signal 302 in a first direction during a first mode or in a second direction during a second mode. In the first mode, the coupler circuit 314 may provide the reference signal 302 to an input of the RFFE 310 (e.g., to a duplexer of the RFFE 310, to a diplexer of the RFFE 310, to a filter of the RFFE 310, or to another component of the RFFE 310). In an example, the RFFE 310, the amplifier 320, and the downconverters 330A, 330B, and 330C correspond to a receive path that is responsive to the reference signal 302.

In the second mode, the coupler circuit 314 may provide the reference signal 302 toward the antenna 312, such as by steering the reference signal 302 to the tuner circuit 316. In the second mode, the reference signal 302 may be reflected from one or more of the antenna 312 or the tuner circuit 316 toward the receive path that includes the RFFE 310, the amplifier 320, and the downconverters 330A, 330B, and 330C.

In some examples, the one or more processors 340 may determine an incident power 346 associated with the reference signal 302 during the first mode and may determine a reflected power 348 associated with the reference signal 302 during the second mode. The one or more processors 340 may determine a voltage standing wave ratio (VSWR) 350 associated with the receiver circuit 300 based on the incident power 346 and the reflected power 348.

The one or more processors 340 may adjust an impedance of the tuner circuit 316 based on the VSWR 350. For example, the tuner circuit 316 may include an adjustable bank of capacitors, and the one or more processors 340 may provide one or more control signals to the tuner circuit 316 to enable or disable one or more capacitors of the adjustable bank of capacitors to reduce the VSWR 350.

Further, other components described herein may be controlled by the one or more processors 340. For example, the reference signal generator 318 may generate the reference signal 302 based on the control signal 304. As another example, a mode of the coupler circuit 314 may be adjusted via a control signal (e.g., from the one or more processors 340).

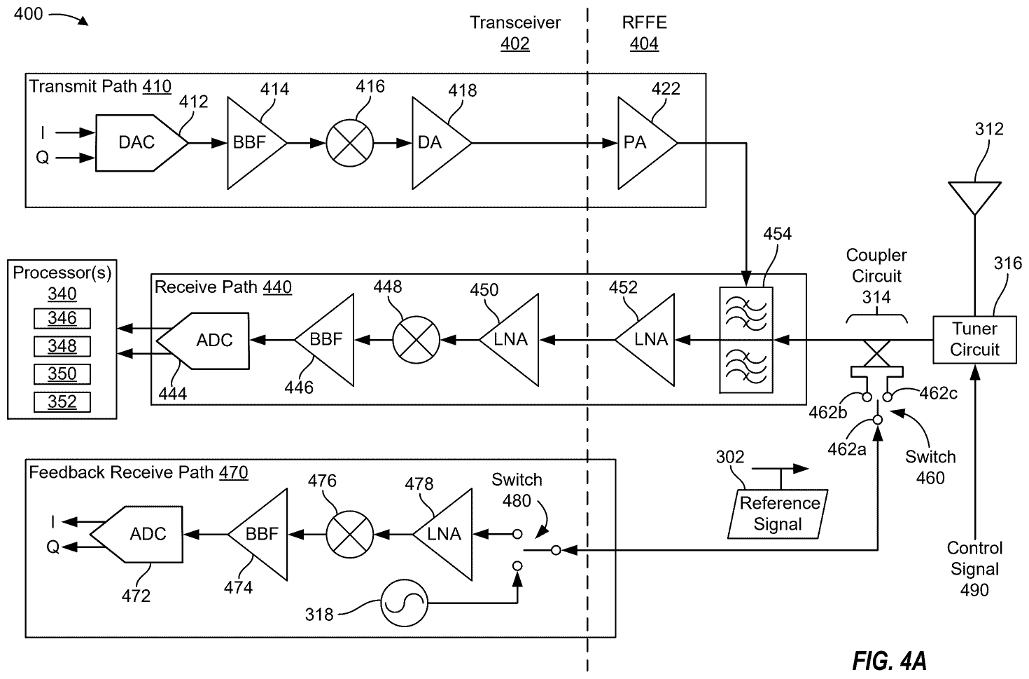

FIG. 4A is a block diagram illustrating an example of a system 400 according to one or more aspects. In some implementations, the system 400 may be included in one or more devices described with reference to FIGS. 1-3, such as the UE 115. The system 400 may include one or more features described with reference to FIG. 3. For example, the system 400 may include the antenna 312, the tuner circuit 316, and the coupler circuit 314.

In the example of FIG. 4A, the coupler circuit 314 may include or may be coupled to a switch 460. The switch 460 may include terminals 462a, 462b, and 462c.

The system 400 may further include a receive path 440. The receive path 440 may be coupled to the coupler circuit 314, to the tuner circuit 316, and to the antenna 312 (e.g., via the tuner circuit 316). In some examples, the receive path 440 may include one or more of a duplexer 454, a low noise amplifier (LNA) 452, an LNA 450, a mixer 448 (e.g., the mixer 332), a baseband filter (BBF) 446 (e.g., the BBF 334), or an analog-to-digital converter (ADC) 444 (e.g., the ADC 336).

In some implementations, the system 400 may optionally include a transmit path 410. The transmit path 410 may include one or more of a digital-to-analog converter (DAC) 412, a BBF 414, a mixer 416, a driver amplifier (DA) 418, or a power amplifier (PA) 422. In some examples, the PA 422 may be coupled to the duplexer 454.

In some implementations, the system 400 may optionally include a feedback receive path 470. The feedback receive path may include or may be coupled to a switch 480. The switch 480 may be coupled to the coupler circuit 314 (e.g., to the switch 460). The feedback receive path 470 may also include an LNA 478, a mixer 476, a BBF 474, and an ADC 472. The LNA 478 may be coupled to the switch 480.

In some examples, the feedback receive path 470 may include or may be coupled to the reference signal generator 318. The reference signal generator 318 may be coupled to the switch 480. In some examples, the reference signal generator 318 may include one or more of a local oscillator (LO), a voltage controlled oscillator (VCO), or a single tone generator (STG), as illustrative examples.

In some implementations, the coupler circuit 314 may include a four-port coupler having a first port, a second port, a third port, and a fourth port. The first port, the second port, the third port, and the fourth port may be coupled to the terminal 462b, the terminal 462c, an input of the receive path 440, and an output of the tuner circuit 316 (and the antenna 312), respectively.

In the example of FIG. 4A, the tuner circuit 316 may be coupled to the output of the coupler circuit 314. The tuner circuit 316 may be further coupled to an output port (e.g., an antenna port) associated with at least one antenna, such as the antenna 312. For example, the output port may correspond to a connection between the input of the receive path 440 and the antenna 312, the tuner circuit 316, or both.

In some implementations, at least some components illustrated in FIG. 4A may be included in a transceiver 402. Further, at least some other components illustrated in FIG. 4A may be included in an RFFE 404 (e.g., the RFFE 310 of FIG. 3). In some implementations, the one or more processors 340 may include a processor included in the transceiver 402, such as an RF controller. Alternatively, or in addition, the one or more processors 340 may include a processor included in another component. For example, the one or more processors 340 may include a processor included in a modem that may be coupled to or included in the system 400. For example, the modem may be coupled to an output of the ADC 444.

During operation, the switch 480 may selectively couple the coupler circuit 314 to an input of the feedback receive path 470 (e.g., the LNA 478) or to an output of the reference signal generator 318. For example, the switch 480 may selectively couple the coupler circuit 314 to the input of the feedback receive path 470 to facilitate a feedback procedure during operation of the transmit path 410 (e.g., while the transmit path 410 is utilizing the antenna 312 to transmit a signal). As another example, the switch 480 may selectively couple the coupler circuit 314 to the output of the reference signal generator 318 to facilitate measurement of the incident power 346 during a first mode and to facilitate measurement of the reflected power 348 during a second mode.

During operation based on the first mode, the coupler circuit 314 may provide the reference signal 302 to the receive path 440 (e.g., to facilitate measurement of the incident power 346). For example, during operation based on the first mode, the coupler circuit 314 may provide the reference signal 302 to an input of the receive path 440 (e.g., to the duplexer 454). The receive path 440 may perform processing of the reference signal 302 (e.g., by amplifying, mixing, filtering, and digitizing the reference signal 302).

During operation based on the second mode, the coupler circuit may provide the reference signal 302 to the tuner circuit 316, to the antenna 312, or both (e.g., to facilitate measurement of the reflected power 348). One or more of the tuner circuit 316 or the antenna 312 may reflect the reference signal 302 (or at least a portion of the reference signal 302) to an input of the receive path 440 (e.g., to the duplexer 454). The receive path 440 may perform processing of the reflection of the reference signal 302 (e.g., by amplifying, mixing, filtering, and digitizing the reflection of the reference signal 302).

To further illustrate, FIG. 4B illustrates an example of a first configuration of the switch 460 during operation of the coupler circuit 314 based on the first mode according to one or more aspects. In the first mode, the terminal 462a may be coupled to the terminal 462b. The first configuration illustrated in FIG. 4B may be referred to as a forward-coupled state of the coupler circuit 314.

FIG. 4C illustrates an example of a second configuration of the switch 460 during operation of the coupler circuit 314 based on the second mode according to one or more aspects. In the second mode, the terminal 462a may be coupled to the terminal 462c. The second configuration illustrated in FIG. 4C may be referred to as a reverse-coupled state of the coupler circuit 314.

Referring again to FIG. 4A, the system 400 may measure the reference signal 302 during operation based on the first mode and may measure the reflection of the reference signal 302 during operation based on the second mode, such as by performing digital in-phase and quadrature (IQ) capture operations to facilitate measurement of the incident power 346 and the reflected power 348. For example, during operation based on the first mode, the one or more processors 340 may capture a first output of the ADC 444. The one or more processors 340 may measure a first amount of power of the first output to determine the incident power 346. As another example, during operation based on the second mode, the one or more processors 340 may capture a second output of the ADC 444. The one or more processors 340 may measure a second amount of power of the second output to determine the reflected power 348.

In some examples, the one or more processors 340 may determine the VSWR 350 based on the incident power 346 and the reflected power 348. To illustrate, the one or more processors 340 may determine a ratio of the reflected power 348 to the incident power 346. The ratio may be referred to as a voltage reflection coefficient and may be indicated by Γ. In some implementations, the VSWR 350 may correspond to (1+Γ)/(1−Γ).

In some implementations, the one or more processors 340 may compare the VSWR 350 to a threshold 352. The threshold 352 may be selected based on the particular application and system design. In some implementations, the threshold 352 may correspond to 1.25 or another value. In other examples, the threshold 352 may be set more “aggressively” (e.g., to 1.1 or another value) or may be “relaxed” (e.g., to 1.4 or another value). Further, in some implementations, the threshold 352 may be configured or modified dynamically during operation.

Based on the VSWR 350 exceeding the threshold 352, the one or more processors 340 may adjust an impedance of the tuner circuit 316, such as via a control signal 490 that the one or more processors 340 may provide to the tuner circuit 316. The control signal 490 may have a value (also referred to herein as a tuner code) indicating a combination of components (e.g., capacitors) of the tuner circuit 316 to be activated or deactivated to adjust the impedance of the tuner circuit 316. For example, the one or more processors 340 may include or may be coupled to a memory storing a lookup table (LUT) that indicates a mapping of VSWR values to tuner codes. In some other examples, based on the VSWR 350 failing to exceed the threshold 352, the one or more processors 340 may maintain the impedance of the tuner circuit 316. Determining the VSWR 350, comparing the VSWR 350 to the threshold 352, and adjusting the impedance of the tuner circuit 316 may be referred to herein as VSWR monitoring.

After adjusting the impedance of the tuner circuit 316, one or more operations may be performed based on the adjusted impedance. For example, the UE 115 may receive one or more downlink signals or one or more sidelink signals (e.g., after connecting the receive path 440 to the antenna 312 via the duplexer 454) based on the adjusted impedance. To further illustrate, the one or more downlink signals may include one or more of a PDSCH signal, a PDCCH signal, or another signal. Alternatively, or in addition, the UE 115 may transmit one or more uplink signals or one or more sidelink signals (e.g., after connecting the transmit path 410 to the antenna 312 via the duplexer 454) based on the adjusted impedance. To further illustrate, the one or more uplink signals may include one or more of a PUSCH signal, a PUCCH signal, or another signal.

In some examples, the one or more processors 340 may detect one or more trigger events associated with VSWR monitoring. The one or more processors 340 may initiate generation of the reference signal 302 (e.g., to facilitate measurement of the incident power 346 and the reflected power 348) based on detecting the one or more trigger events associated with VSWR monitoring. In some examples, the one or more trigger events may include a period of inactivity associated with the receive path 440.

To further illustrate, in some examples, detecting the one or more trigger events may include detecting that no downlink signal (or particular type of downlink signal, such as a PDCCH signal) is scheduled to be received. In such examples, VSWR monitoring may be performed during or more “free” slots (e.g., when no downlink signal is scheduled to be received). In some other examples, if no “free” slots are detected, downlink signal reception may be interrupted to perform VSWR monitoring. For example, at least some decode operations associated with a PDSCH signal may be “dropped” to enable VSWR monitoring. A slot that is “dropped” may be requested for retransmission (e.g., via a NACK).

Alternatively, or in addition, detecting the one or more trigger events may include detecting initiation of a mode of operation specified by a wireless communication specification. For example, VSWR monitoring may be initiated based on the UE 115 initiating any of an idle mode, a connected mode, a discontinuous receive (DRx) mode, a connected discontinuous receive (CDRx) mode, or an extended DRx mode, as illustrative examples. Further, in some implementations, VSWR monitoring may be performed immediately prior to initiation of such a mode of operation (e.g., to reduce or avoid waking the UE 115 during such a mode of operation).

Alternatively, or in addition, detecting the one or more trigger events may include determining that a signal-to-noise ratio (SNR) associated with a received signal satisfies a condition, such as if the SNR fails to exceed a threshold SNR. In such examples, the one or more processors 340 may monitor SNR of received signals and may selectively initiate VSWR monitoring based on a particular SNR failing to exceed the threshold SNR. In some examples, the threshold SNR may be 5 decibels (dB), 6 dB, 7 dB, or another value, as illustrative examples. The threshold SNR may be associated with a sensitivity range, such as a sensitivity range of 10 db (e.g., −4 dB to 6 dB).

Alternatively, or in addition, detecting the one or more trigger events may include detecting that a threshold time interval has elapsed since previously performing VSWR monitoring. In some such examples, VSWR monitoring may be performed on a periodic or semi-periodic basis. To further illustrate, in some implementations, VSWR monitoring may be performed every 5 milliseconds (ms) for two time slots (e.g., two consecutive time slots). Other examples are also within the scope of the disclosure. In some examples, performing VSWR monitoring during consecutive slots may reduce or avoid certain temporary effects of noise or interference.

In some examples, VSWR monitoring may be performed separately for different configurations, and different respective impedances may be set at the tuner circuit 316 during operation based on the different configurations. For example, VSWR monitoring may be performed separately for each signal path having a unique antenna association, for each single carrier configuration, for each MIMO configuration, for each uplink carrier aggregation (ULCA) configuration, for each Evolved-Universal Terrestrial Radio Access (EUTRA) New Radio dual connectivity (ENDC) configuration, for one or more other configurations, or a combination thereof, as illustrative examples.

In some examples, VSWR monitoring may be performed separately for different types of operations, and different respective impedances may be set at the tuner circuit 316 during the different types of operations. For example, VSWR monitoring may be performed separately for frequency division duplex (FDD) operation and for time division duplex (TDD) operation. As another example, for TDD operation, VSWR monitoring may be performed during a downlink-to-uplink switch or during one or more downlink slots.

In some examples, an apparatus includes a receive circuit, an antenna tuner circuit, and a coupler circuit coupled between the receive circuit and the antenna tuner circuit. For example, the receive circuit may include the receive path 440 or one or more components of the receive path 440. The antenna tuner circuit may correspond to the tuner circuit 316, and the coupler circuit may correspond to the coupler circuit 314. The coupler circuit may have a first port and a second port. The first port may be forward-coupled port that is coupled to the receive circuit, and the second port may be a reverse-coupled port that is coupled to the antenna tuner circuit. The apparatus may further include a feedback receiver circuit (e.g., the feedback receive path 470), a reference signal generator (e.g., the reference signal generator 318), a first switching circuit (e.g., the switch 460), and a second switching circuit (e.g., the switch 480). The first switching circuit may be coupled between the coupler circuit and each of the feedback receiver circuit and the reference signal generator. The first switching circuit may be configured to selectively couple to either the first port or the second port of the coupler circuit. The second switching circuit may be coupled between the first switching circuit and each of the feedback receiver circuit and the reference signal generator. The second switching circuit may be configured to selectively couple to either the feedback receiver circuit or the reference signal generator.

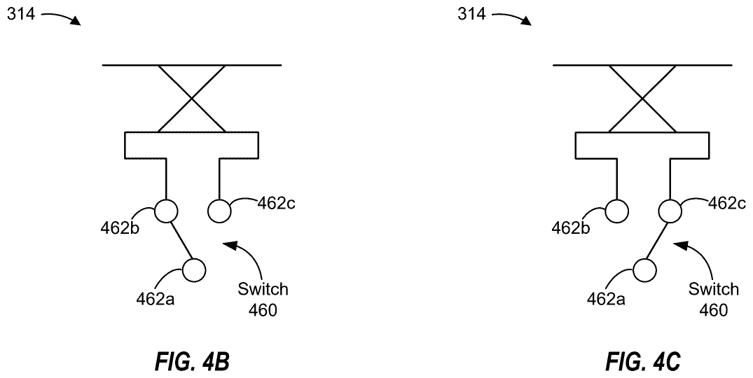

FIG. 5A is a block diagram illustrating an example configuration of a time slot 500a according to one or more aspects. The time slot 500a may include multiple symbols. In the example of FIG. 5A, the time slot 500a may include fourteen symbols (indicated as symbols 0, 1, 2, 3, 4, 5, 6, 7, 8, 9, 10, 11, 12, and 13).

In the example of FIG. 5A, symbols 0 and 1 of the time slot 500a may be used to perform a receive operation 502, such as a downlink receive operation or a sidelink receive operation. In some examples, the receive operation 502 may be performed by the receiver circuit 300 or the system 400 (e.g., using the receive path 440).

Symbols 2 and 3 of the time slot 500a may be associated with a settling time 504. For example, one or more components may be configured during the settling time 504, such as by adjusting a frequency of operation of the reference signal generator 318.

Symbols 4-13 of the time slot 500a may be available for VSWR monitoring and may correspond to a time 506 available for VSWR monitoring. In some examples, at least some of symbols 2-13 may correspond to unscheduled symbols during which no downlink signal is scheduled for the UE 115. In some other examples, at least some of symbols 2-13 may correspond to “dropped” symbols. During a dropped symbol, the UE 115 may be scheduled to receive a downlink signal and may avoid receiving the downlink signal. In some examples, the UE 115 may request retransmission of such a dropped symbol (e.g., via a NACK).

In some implementations, the time slot 500a may be associated with NR TDD 30K SCS operation and may have a first duration, such as a duration of approximately 500 microseconds (μs). To further illustrate, in some examples, symbols 0 and 1 may occupy 70 μs, symbols 2 and 3 may occupy 70 μs, and symbols 4-13 may occupy 360 μs.

Referring to FIG. 5B, in some other implementations, a time slot 500b may be associated with NR FDD 15 KHz SCS/LTE 15 KHz SCS operation and may have a second duration, such as a duration of approximately 1 millisecond (ms). To further illustrate, in some examples, symbols 0 and 1 may occupy 140 μs, symbol 2 may occupy 70 μs, and symbols 3-13 may occupy approximately 800 μs. Other examples are also within the scope of the disclosure.

In the example of FIG. 5B, symbols 0 and 1 of the time slot 500b may be used to perform the receive operation 502, such as a downlink receive operation or a sidelink receive operation. In some examples, the receive operation 502 may be performed by the receiver circuit 300 or the system 400 (e.g., using the receive path 440).

Symbol 2 of the time slot 500b may be associated with the settling time 504. For example, one or more components may be configured during the settling time 504, such as by adjusting a frequency of operation of the reference signal generator 318.

Symbols 3-13 of the time slot 500b may correspond to the time 506 available for VSWR monitoring. In some examples, at least some of symbols 2-13 may correspond to unscheduled symbols during which no downlink signal is scheduled for the UE 115. In some other examples, at least some of symbols 2-13 may correspond to “dropped” symbols. During a dropped symbol, the UE 115 may be scheduled to receive a downlink signal and may avoid receiving the downlink signal. In some examples, the UE 115 may request retransmission of such a dropped symbol (e.g., via a NACK).

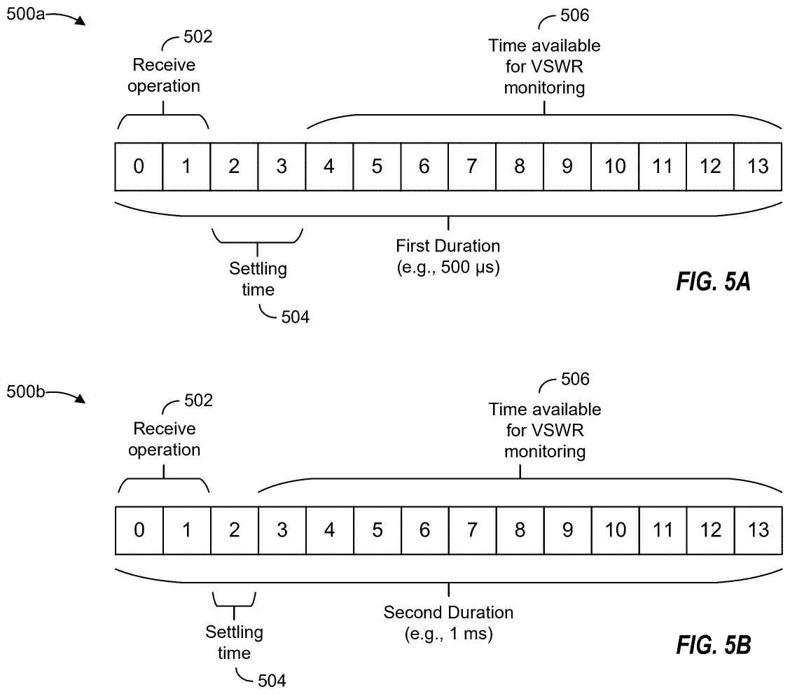

In some examples, VSWR monitoring may be performed iteratively (e.g., by iteratively measuring the VSWR 350 and updating the impedance of the tuner circuit 316 until the VSWR 350 “converges” to a particular value or until a particular condition is satisfied). Some illustrative examples that may be associated with iterative VSWR monitoring are described further with reference to FIG. 6.

FIG. 6 illustrates an example of a method 600 according to one or more aspects. In some examples, the method 600 may be performed by a device described herein, such as the UE 115, the receiver circuit 300, the system 400, or another device.

The method 600 may include detecting one or more trigger events associated with VSWR monitoring, at 604. In some examples, the one or more trigger events may include, for example, initiating of a sleep mode. The sleep mode may include, for example, an idle mode of operation of the UE 115, an idle mode of operation of the receiver circuit 300, or an idle mode of operation of the system 400. For example, the UE 115 may detect the one or more trigger events based on determining that no wireless communication operation is scheduled for at least a particular time interval. Alternatively, or in addition, the one or more trigger events may include one or more other events, such as detecting a change in a physical orientation of the UE 115, which may change or increase VSWR.

The method 600 may further include recording a timestamp TO and configuring one or more components for incident power measurement, at 608. For example, the one or more components may include one or more of the coupler circuit 314, the reference signal generator 318, the switch 460, the switch 480, or one or more other components. In some examples, configuring the one or more components may include setting a frequency of the reference signal 302 (e.g., based on the receive frequency 342 and the frequency offset 344), connecting the reference signal generator 318 to the coupler circuit 314 via the switch 480, and setting the switch 460 to a forward-coupled state (e.g., as illustrated in the example of FIG. 4B), and providing a control signal to the reference signal generator 318 to generate the reference signal 302. In some examples, the frequency of the reference signal 302 is based on a receive frequency associated with the receive path 440, such as the receive frequency 342. In some examples, the frequency of the reference signal 302 is based on a sum of the receive frequency 342 and the frequency offset 344.

The method 600 may further include measuring an incident power, at 612. For example, the one or more processors 340 may measure the incident power 346.

The method 600 may further include writing an indication of the incident power to a buffer, at 616. For example, the one or more processors 340 may store an indication of the incident power 346 to a buffer or other memory that may be included in or accessible to the one or more processors 340.

The method 600 may further include waiting a delay time interval, at 620. For example, the delay time interval may be selected to isolate measurement of the reflected power 348 from measurement of the incident power 346. In some examples, the reference signal generator 318 may operate based on a standby mode of operation during the delay time interval.

The method 600 may further include reconfiguring the one or more components for reflected power measurement, at 624. For example, reconfiguring the one or more components may include connecting the reference signal generator 318 to the coupler circuit 314 via the switch 480, and setting the switch 460 to a reverse-coupled state (e.g., as illustrated in the example of FIG. 4C), and providing a control signal to the reference signal generator 318 to generate the reference signal 302.

The method 600 may further include measuring a reflected power, at 628. For example, the one or more processors 340 may measure the reflected power 348.

The method 600 may further include writing an indication of the reflected power to the buffer and restoring the one or more components to a prior state, at 632. For example, the one or more processors 340 may store an indication of the reflected power 348 to a buffer or other memory that may be included in or accessible to the one or more processors 340. In some examples, restoring the one or more components to the prior state may include disconnecting (e.g., via the switch 480) the reference signal generator 318 from the coupler circuit 314 and placing the reference signal generator 318 in a standby mode of operation.

The method 600 may further include estimating VSWR, generating a tuner code for iterative VSWR reduction, and recording a timestamp T1, at 636. For example, the one or more processors 340 may determine the VSWR 350 and may generate the tuner code based on the VSWR 350. The control signal 490 may indicate the tuner code.

The method 600 may further include one or more of determining whether the VSWR is less than equal to a threshold or whether the VSWR is equal to a prior VSWR value, at 640. For example, the one or more processors may compare the VSWR 350 to the threshold 352 and to a prior VSWR value determined during a prior iteration of the method 600 (if any).

In some examples, if the VSWR is less than or equal to the threshold, or if the VSWR is equal to the prior VSWR value, the method 600 may further include determining whether a time difference T1-TO exceeds a threshold time interval, at 644. The threshold time interval may correspond to or may be based on a time available for VSWR monitoring, such as the time 506 of FIG. 5A or FIG. 5B. If the time difference T1-TO exceeds the threshold time interval, the method 600 may terminate, at 652. If the time difference fails to exceed the threshold time interval, the method 600 may include updating a tuner code through RFFE, at 648, and may terminate, at 652. For example, an impedance of the tuner circuit 316 may be adjusted via the control signal 490.

In some other examples, if the VSWR exceeds the threshold, and if the VSWR is unequal to the prior VSWR value, the method 600 may further include determining whether a time difference T1-TO exceeds a threshold time interval, at 656. If the time difference T1-TO exceeds the threshold time interval, the method 600 may terminate, at 652. If the time difference T1-TO fails to exceed the threshold time interval, the method 600 may further include determining whether the VSWR exceeds a prior VSWR value, at 660, and updating a tuner code through RFFE (e.g., by adjusting an impedance of the tuner circuit 316 via the control signal 490), at 664. The method 600 may continue, at 604.

If the time difference T1-T0 exceeds the threshold time interval, the method 600 may further include updating the tuner code in a complementary direction through RFFE, at 668. For example, if increasing capacitance of the tuner circuit 316 via the control signal 490 results in increased VSWR during an iteration of the method 600, then updating the tuner code in the complementary direction at 668 may include decreasing capacitance of the tuner circuit 316 via the control signal 490. As another example, if decreasing capacitance of the tuner circuit 316 via the control signal 490 results in increased VSWR during an iteration of the method 600, then updating the tuner code in the complementary direction at 668 may include increasing capacitance of the tuner circuit 316 via the control signal 490. The method 600 may continue, at 604.

One or more features described herein may improve performance of a device, such as the UE 115. For example, by monitoring the VSWR 350 during operation of the UE 115, the UE 115 may adaptively adjust the impedance of the tuner circuit 316, which may change the impedance that is “seen” by the input of the receive path 440. As a result, the UE 115 may compensate for changes to capacitance associated with the antenna 312 that may vary during operation of the UE 115, such as changes to capacitance due to the hand of a user blocking the antenna 312. As a result, SNR at the UE 115 may be increased, which may improve performance of the UE 115 and decrease power consumption of the UE 115. As a result, receiver sensitivity of the receive path 440 may be increased, which may improve performance of the UE 115 and which may decrease power consumption of the UE 115 in some circumstances.

Although some examples may be described herein with reference to a UE (such as the UE 115), other examples are also within the scope of the disclosure. For example, in some implementations, another device, such as a network node, may perform one or more operations described with reference to the UE 115. In some examples, the network node may include or may correspond to the base station 105.

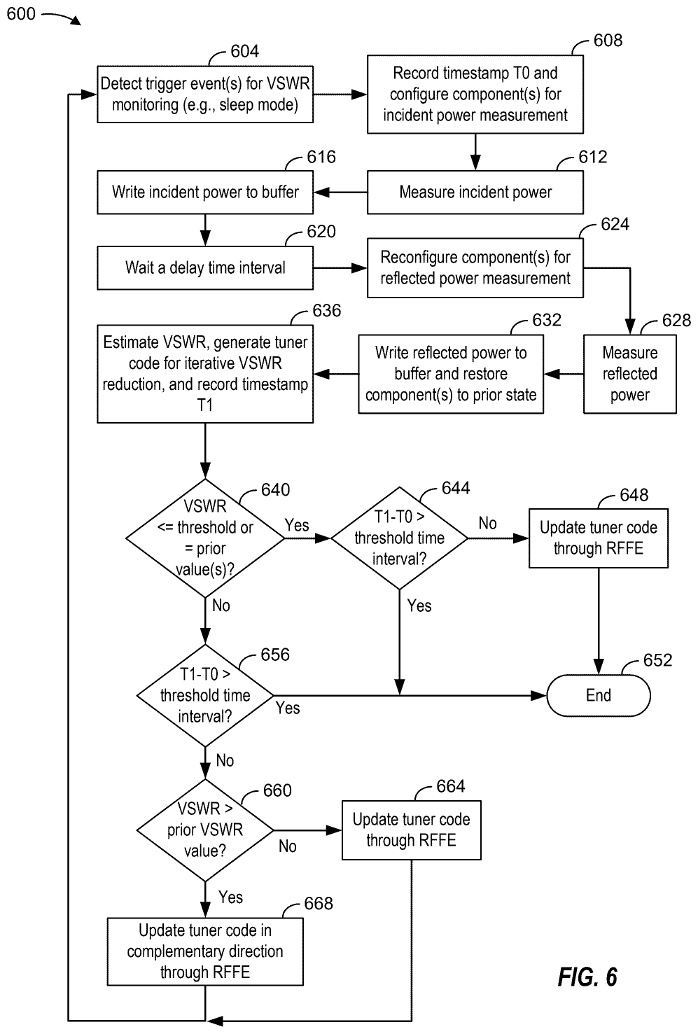

FIG. 7 is a flow chart illustrating an example of a method 700 according to one or more aspects. In some examples, the method 700 may be performed by one or more devices described herein, such as by the UE 115.

The method 700 includes receiving an indication of an incident power associated with a receive path, at 702. Measurement of the incident power is associated with a first mode of a coupler circuit that is coupled to the receive path. For example, the one or more processors 340 may receive an indication of the incident power 346 associated with the receive path 440, and measurement of the incident power 346 may be associated with a forward-coupled state of the coupler circuit 314, such as illustrated in the example of FIG. 4B.

The method 700 further includes receiving an indication of a reflected power associated with a tuner circuit, at 704. Measurement of the reflected power is associated with a second mode of the coupler circuit, the coupler circuit coupled to the tuner circuit. For example, the one or more processors 340 may receive an indication of the reflected power 348 associated with the tuner circuit 316, and measurement of the reflected power 348 may be associated with a reverse-coupled state of the coupler circuit 314, such as illustrated in the example of FIG. 4C.

The method 700 further includes providing a control signal to the tuner circuit to adjust an impedance associated with the tuner circuit, at 706. The control signal is based on the incident power and the reflected power. For example, the one or more processors 340 may provide the control signal 490 to the tuner circuit 316 based on the incident power 346 and the reflected power 348.

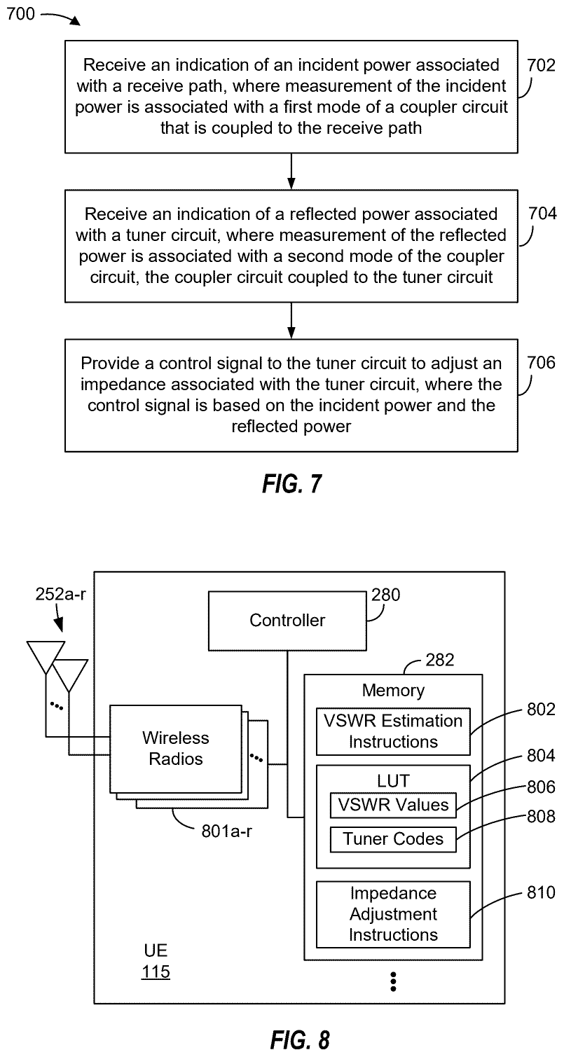

FIG. 8 is a block diagram of an example UE 115 according to one or more aspects. The UE 115 may include structure, hardware, or components described herein. For example, the UE 115 may include the controller 280, which may execute instructions stored in the memory 282. Using the controller 280, the UE 115 may transmit and receive signals via wireless radios 801a-r and antennas 252a-r. The wireless radios 801a-r may include one or more components or devices described herein, such as the modulator/demodulators 254a-r, the MIMO detector 256, the receive processor 258, the transmit processor 264, the TX MIMO processor 266, the receiver circuit 300, the system 400, one or more other components or devices, or a combination thereof.

In some examples, the memory 282 may store instructions executable by the controller 280 to initiate, perform, or control one or more operations described herein. For example, the memory 282 may store VSWR estimation instructions 802 executable by the controller 280 to determine the VSWR 350 based on the incident power 346 and the reflected power 348. To illustrate, the controller 280 may execute the VSWR estimation instructions 802 to determine a ratio of the reflected power 348 to the incident power 346. The ratio may be referred to as a voltage reflection coefficient and may be indicated by. In some implementations, the VSWR 350 may correspond to (1+Γ)/(1−Γ).

As another example, the memory 282 may store a lookup table (LUT) 804 that is accessible to the controller 280. The LUT 804 may indicate a mapping of values 806 of the VSWR 350 to tuner codes 808 of the control signal 490. In some examples, based on determining a particular value of the VSWR 350, the controller 280 may select a particular tuner code of the tuner codes 808 corresponding to the particular value of the VSWR 350.

As an additional example, the memory 282 may store impedance adjustment instructions 810 executable by the controller 280 to adjust impedance of the tuner circuit 316 (e.g., by applying the particular tuner code to the tuner circuit 316 via the control signal 490).

To further illustrate some aspects of the disclosure, in a first aspect, an apparatus includes a receive path, a tuner circuit, and a coupler circuit. The coupler circuit is configured to provide a reference signal to the receive path in a first mode of operation associated with measurement of an incident power associated with the receive path. The coupler circuit is further configured to provide the reference signal to the tuner circuit in a second mode of operation associated with measurement of a reflected power from the tuner circuit to the receive path. The tuner circuit is configured to receive a control signal in accordance with the incident power and the reflected power. The control signal indicates an impedance adjustment associated with the tuner circuit.

In a second aspect in combination with the first aspect, the tuner circuit is further configured to receive the control signal based on a voltage standing wave ratio (VSWR) exceeding a threshold, and the VSWR is based on a ratio of the reflected power to the incident power.

In a third aspect in combination with one or more of the first aspect or the second aspect, the coupler circuit includes a switch that is associated with a forward-coupled state during the first mode and a reverse-coupled state during the second mode, and the switch is configured to provide the reference signal to the receive path in the forward-coupled state and to provide the reference signal to the tuner circuit in the reverse-coupled state.

In a fourth aspect in combination with one or more of the first aspect through the third aspect, the apparatus further includes a reference signal generator configured to generate the reference signal and a feedback receive path that includes or that is coupled to the reference signal generator.

In a fifth aspect in combination with one or more of the first aspect through the fourth aspect, the feedback receive path includes a switch configured to selectively couple the coupler circuit to an input of the feedback receive path or to an output of the reference signal generator.

In a sixth aspect in combination with one or more of the first aspect through the fifth aspect, the reference signal has a frequency that is based on a sum of a receive frequency associated with the receive path and a frequency offset.

In a seventh aspect in combination with one or more of the first aspect through the sixth aspect, the tuner circuit is coupled to an input port of the receive path and is further coupled to an output port associated with at least one antenna.

In an eighth aspect, a method includes receiving an indication of an incident power associated with a receive path and further includes receiving an indication of a reflected power associated with a tuner circuit. Measurement of the incident power is associated with a first mode of a coupler circuit that is coupled to the receive path, and measurement of the reflected power is associated with a second mode of the coupler circuit. The coupler circuit is coupled to the tuner circuit. The method further includes providing a control signal to the tuner circuit to adjust an impedance associated with the tuner circuit. The control signal is based on the incident power and the reflected power.

In a ninth aspect in combination with the eighth aspect, the method further includes detecting one or more trigger events associated with voltage standing wave ratio (VSWR) monitoring. The method further includes, based on detecting the one or more trigger events, initiating generation of a reference signal to facilitate measurement of the incident power and the reflected power.

In a tenth aspect in combination with one or more of the eighth aspect through the ninth aspect, the one or more trigger events include a period of inactivity associated with the receive path.

In an eleventh aspect, in combination with one or more of the eighth aspect through the ninth aspect, the method further includes determining a voltage standing wave ratio (VSWR) based on a ratio of the reflected power to the incident power.

In a twelfth aspect in combination with one or more of the eighth aspect through the eleventh aspect, the method further includes determining that the VSWR satisfies a threshold, and the control signal is based further on the VSWR satisfying the threshold.

In a thirteenth aspect in combination with one or more of the eighth aspect through the twelfth aspect, the reference signal has a frequency that is based on a sum of a receive frequency associated with the receive path and a frequency offset.

In a fourteenth aspect, an apparatus includes a processing system including one or more processors and one or more memories coupled to the one or more processors. The processing system is configured to receive an indication of an incident power associated with a receive path and to receive an indication of a reflected power associated with a tuner circuit. Measurement of the incident power is associated with a first mode of a coupler circuit that is coupled to the receive path, and measurement of the reflected power is associated with a second mode of the coupler circuit. The coupler circuit coupled to the tuner circuit. The processing system is further configured to provide a control signal to the tuner circuit to adjust an impedance associated with the tuner circuit. The control signal is based on the incident power and the reflected power.

In a fifteenth aspect in combination with the fourteenth aspect, the processing system is further configured to detect one or more trigger events associated with voltage standing wave ratio (VSWR) monitoring and to initiate, based on the one or more trigger events, generation of a reference signal to facilitate measurement of the incident power and the reflected power.

In a sixteenth aspect in combination with one or more of the fourteenth aspect through the fifteenth aspect, the one or more trigger events include a period of inactivity associated with the receive path.

In a seventeenth aspect in combination with one or more of the fourteenth aspect through the sixteenth aspect, the processing system is further configured to determine a voltage standing wave ratio (VSWR) based on a ratio of the reflected power to the incident power.

In an eighteenth aspect in combination with one or more of the fourteenth aspect through the seventeenth aspect, the processing system is further configured to determine that the VSWR satisfies a threshold and to provide the control signal to the tuner circuit based further on the VSWR satisfying the threshold.

In a nineteenth aspect in combination with one or more of the fourteenth aspect through the eighteenth aspect, the reference signal has a frequency that is based on a sum of a receive frequency associated with the receive path and a frequency offset.

In a twentieth aspect, in combination with one or more of the fourteenth aspect through the nineteenth aspect, the processing system is further configured to measure the incident power while a switch of the coupler circuit is associated with a forward-coupled state and to measure the reflected power while the switch is associated with a reverse-coupled state.

In a twenty-first aspect, an apparatus includes a receive circuit, an antenna tuner circuit, and a coupler circuit. The coupler circuit is coupled between the receive circuit and the antenna tuner circuit and has a first port and a second port. The apparatus further includes a feedback receiver circuit, a reference signal generator, and first switching circuit, and a second switching circuit. The first switching circuit is coupled between the coupler circuit and each of the feedback receiver circuit and the reference signal generator. The first switching circuit is configured to selectively couple to either the first port or the second port of the coupler circuit. The second switching circuit is coupled between the first switching circuit and each of the feedback receiver circuit and the reference signal generator. The second switching circuit is configured to selectively couple to either the feedback receiver circuit or the reference signal generator.

In a twenty-second aspect in combination with the twenty-first aspect, the first port is a forward-coupled port that is coupled to the receive circuit.

In a twenty-third aspect in combination with one or more of the twenty-first aspect through the twenty-second aspect, the first switching circuit is configured to receive a reference signal from the reference signal generator and to provide the reference signal to the receive circuit via the first port.

In a twenty-fourth aspect in combination with one or more of the twenty-first aspect through the twenty-third aspect, the second port is a reverse-coupled port that is coupled to the antenna tuner circuit.

In a twenty-fifth aspect in combination with one or more of the twenty-first aspect through the twenty-fourth aspect, the first switching circuit is configured to receive a reference signal from the reference signal generator and to provide the reference signal to the antenna tuner circuit via the second port.

In a twenty-sixth aspect in combination with one or more of the twenty-first aspect through the twenty-fifth aspect, the apparatus further includes an antenna coupled to the antenna tuner circuit.

In a twenty-seventh aspect in combination with one or more of the twentieth aspect through the twenty-sixth aspect, the antenna tuner circuit is coupled to an input of the receive circuit via the coupler circuit, and the antenna tuner circuit is further coupled to an output of the antenna.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

One or more components, functional blocks, and features described herein may include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

The various illustrative logics, logical blocks, modules, circuits and operations described herein may be implemented as electronic hardware, computer software, or combinations of both. Whether such functionality is implemented in hardware or software may depend upon the particular application and design of the overall system.

A hardware and data processing apparatus used to implement the various illustrative logics, logical blocks, modules and circuits described in connection with the aspects disclosed herein may be implemented or performed with a single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor may be a microprocessor, controller, microcontroller, state machine, or other processor. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, one or more functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes computer storage media. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, opposing terms such as “upper” and “lower” or “front” and back” or “top” and “bottom” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes .1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. An apparatus comprising:
a receive path;
a tuner circuit; and
a coupler circuit configured to:
provide a reference signal to the receive path in a first mode of operation associated with measurement of an incident power associated with the receive path; and
provide the reference signal to the tuner circuit in a second mode of operation associated with measurement of a reflected power from the tuner circuit to the receive path,
wherein the tuner circuit is configured to receive a control signal in accordance with the incident power and the reflected power, the control signal indicating an impedance adjustment associated with the tuner circuit.

2. The apparatus of claim 1, wherein the tuner circuit is further configured to receive the control signal based on a voltage standing wave ratio (VSWR) exceeding a threshold, and wherein the VSWR is based on a ratio of the reflected power to the incident power.

3. The apparatus of claim 1, wherein the coupler circuit includes a switch that is associated with a forward-coupled state during the first mode and a reverse-coupled state during the second mode, and wherein the switch is configured to provide the reference signal to the receive path in the forward-coupled state and to provide the reference signal to the tuner circuit in the reverse-coupled state.

4. The apparatus of claim 1, further comprising:
a reference signal generator configured to generate the reference signal; and
a feedback receive path that includes or that is coupled to the reference signal generator.

5. The apparatus of claim 4, wherein the feedback receive path includes a switch configured to selectively couple the coupler circuit to an input of the feedback receive path or to an output of the reference signal generator.

6. The apparatus of claim 1, wherein the reference signal has a frequency that is based on a sum of a receive frequency associated with the receive path and a frequency offset.

7. The apparatus of claim 1, wherein the tuner circuit is coupled to an input port of the receive path and is further coupled to an output port associated with at least one antenna.

8. A method comprising:
receiving an indication of an incident power associated with a receive path, wherein measurement of the incident power is associated with a first mode of a coupler circuit that is coupled to the receive path;
receiving an indication of a reflected power associated with a tuner circuit, wherein measurement of the reflected power is associated with a second mode of the coupler circuit, the coupler circuit coupled to the tuner circuit; and
providing a control signal to the tuner circuit to adjust an impedance associated with the tuner circuit, wherein the control signal is based on the incident power and the reflected power.

9. The method of claim 8, further comprising:
detecting one or more trigger events associated with voltage standing wave ratio (VSWR) monitoring; and
based on detecting the one or more trigger events, initiating generation of a reference signal to facilitate measurement of the incident power and the reflected power.

10. The method of claim 9, wherein the reference signal has a frequency that is based on a sum of a receive frequency associated with the receive path and a frequency offset.

11. The method of claim 9, wherein the one or more trigger events include a period of inactivity associated with the receive path.

12. The method of claim 8, further comprising determining a voltage standing wave ratio (VSWR) based on a ratio of the reflected power to the incident power.

13. The method of claim 12, further comprising determining that the VSWR satisfies a threshold, and wherein the control signal is based further on the VSWR satisfying the threshold.

14. An apparatus comprising:
a receive circuit;
an antenna tuner circuit;
a coupler circuit coupled between the receive circuit and the antenna tuner circuit and having a first port and a second port;
a feedback receiver circuit;
a reference signal generator;
a first switching circuit coupled between the coupler circuit and each of the feedback receiver circuit and the reference signal generator, the first switching circuit configured to selectively couple to either the first port or the second port of the coupler circuit; and
a second switching circuit coupled between the first switching circuit and each of the feedback receiver circuit and the reference signal generator, the second switching circuit configured to selectively couple to either the feedback receiver circuit or the reference signal generator.

15. The apparatus of claim 14, wherein the first port is a forward-coupled port that is coupled to the receive circuit.

16. The apparatus of claim 14, wherein the first switching circuit is configured to receive a reference signal from the reference signal generator and to provide the reference signal to the receive circuit via the first port.

17. The apparatus of claim 14, wherein the second port is a reverse-coupled port that is coupled to the antenna tuner circuit.

18. The apparatus of claim 14, wherein the first switching circuit is configured to receive a reference signal from the reference signal generator and to provide the reference signal to the antenna tuner circuit via the second port.

19. The apparatus of claim 14, further comprising an antenna coupled to the antenna tuner circuit.

20. The apparatus of claim 19, wherein the antenna tuner circuit is coupled to an input of the receive circuit via the coupler circuit, and wherein the antenna tuner circuit is further coupled to an output of the antenna.
